(19) United States
(12) Patent Application Publication
(10) Pub. No.: US 2025/0054226 A1
(43) Pub. Date: Feb. 13, 2025

(54) NOVEL VIEW SYNTHESIS OF DYNAMIC SCENES USING MULTI-NETWORK CODEC EMPLOYING TRANSFER LEARNING

(71) Applicant: IKIN, Inc., Dripping Springs, TX (US)

(72) Inventors: Taylor Scott GRIFFITH, Austin, TX (US); Bryan WESTCOTT, Austin, TX (US)

(21) Appl. No.: 18/789,105

(22) Filed: Jul. 30, 2024

Related U.S. Application Data
(60) Provisional application No. 63/518,835, filed on Aug. 10, 2023.

(51) Int. Cl. G06T 15/20; G06T 15/08

(52) U.S. Cl. CPC G06T 15/205; G06T 15/08

(57) ABSTRACT

A computer implemented method includes receiving keyframe images of a scene captured at an initial time and first images of the scene captured a first time following the initial time. Each of the keyframe images is associated with a corresponding three-dimensional (3D) camera location and camera direction included within a set of keyframe camera extrinsics and each of the first frame images is associated with a corresponding 3D camera location and camera direction included within a set of first frame camera extrinsics. A keyframe neural network is trained using the keyframe images and the keyframe camera extrinsics. A first frame neural network is trained using the first frame images and the first frame camera extrinsics. The first frame neural network is configured to be queried to produce a first novel view of an appearance of the scene at the first time.

### CROSS-REFERENCE TO RELATED APPLICATION

This application claims priority to U.S. Provisional Patent Application 63/518,835, filed Aug. 10, 2023, the contents of which are incorporated herein by reference.

### FIELD

The present disclosure generally relates to techniques for generating three-dimensional (3D) scene representations and, more particularly, to creating virtual views of 3D scenes originally captured using two-dimensional (2D) images.

### BACKGROUND

Dynamic scenes, such as live sports events or concerts, are often captured using multi-camera setups to provide viewers with a range of different perspectives. Traditionally, this has been achieved using fixed camera positions, which limits the viewer's experience to a predefined set of views. Generating photorealistic views of dynamic scenes from additional views (beyond the fixed camera views) is a highly challenging topic that is relevant to applications such as, for example, virtual and augmented reality. Traditional mesh-based representations are often incapable of realistically representing dynamically changing environments containing objects of varying opacity, differing specular surfaces, and otherwise evolving scene environments. However, recent advances in computational imaging and computer vision have led to the development of new techniques for generating virtual views of dynamic scenes.

One such technique is the use of neural radiance fields (NeRFs), which allows for the generation of high-quality photorealistic images from novel viewpoints. NeRFs are based on a neural network that takes as input a 3D point in space and a camera viewing direction and outputs the radiance, or brightness, of that point. This allows for the generation of images from any viewpoint by computing the radiance at each pixel in the image. NeRF enables highly accurate reconstructions of complex scenes. Despite being of relatively compact size, the resulting NeRF models of a scene allow for fine-grained resolution to be achieved during the scene rendering process.

FIG. 1A illustrates a conventional process 10 for training a NeRF-based system to generate reconstructed views of a scene using captured images of the scene. As shown, training images 14 of the scene are provided along with associated camera extrinsics 18 (i.e., a camera location in the form of voxel coordinates (x,y,z) and a camera pose in the form of an azimuth and elevation) as input to a neural network 20 implementing a NeRF. The neural network 20 is trained to define a color (R, G, B) and opacity (alpha) specific to each 3D scene coordinate and viewing direction. During the training process a volume renderer 28 uses the neural network 20 for inference many times per pixel to create generated RGB (D) imagery 32 corresponding to the scene. The supervision label used during training of the NeRF is the associated collected imagery 32, which is compared 40 to the training imagery 14. The weights of the neural network 20 are then adjusted 44 based upon this comparison.

Referring to FIG. 1B, once training has been completed, the NeRF modeled by neural network 20 may be queried using novel camera view(s) 19 specifying one or more viewing positions and directions corresponding to one or more virtual cameras. In response, the volume renderer 28 generates RGB (D) imagery corresponding to view(s) of the scene from the viewing position(s) and direction(s) specified by the novel camera view(s) 19. Depth may optionally be computed using various volume rendering techniques such as the known “marching cubes” method.

FIG. 2 illustrates a high-level neural architecture of a neural network implementing a conventional NeRF. The conventional high-level architecture of the neural network 200 is described in “Nerf: Representing scenes as neural radiance fields for view synthesis” Mildenhall et al., arXiv 2003.08934v1 19 Mar. 2020. As shown, the conventional neural network 200 configured for NeRF includes a 5-channel input layer 204, an upsampling layer 208, fully connected layers 212, a pooling layer 216 and an output layer 220. The 5-channel input layer 204 takes in position (x, y and z) and viewing direction (θ and ϕ). The channel input layer 204 is expanded to more channels (aka neurons) via upsampling layer 208 to the larger fully connected layers 212, which may have many channels (e.g., 256). Each channel of the fully connected layers 212 is connected to the next layer, and the output is a weighted sum of incoming connections with a non-linear activation function (e.g., ReLU) applied. The pooling layer 216 reduces the channels to the output layer 220, which consists of 4-channel color information (r, g, b) and transparency (α). As a unique weight is learned for each internal connection, the training time and model size can be large. As each layer is fully connected with the next, a large amount of computation is required for each voxel position and viewing direction input (both for training and inference).

FIG. 3 provides a more detailed view of an exemplary neural network implementing a conventional NeRF. As shown, the neural network 300 includes a 5-channel input layer 304, an upsampling layer 308, fully connected layers 312, a pooling layer 316 and a 4-channel output layer 320. In exemplary implementations, each of the fully connected layers 312 has 256 channels and the pooling layer 316 has 128 channels. This results in a large number of network connections, thus requiring a correspondingly large amount of data to characterize the network. For example, in the case of 9 fully-connected layers 312 there are 524,288 connections (8×256²), which is in addition to the connections between and among the other layers of the neural network 300.

Unfortunately, the large amount of data required to store radiance information for a NeRF modeling a high-resolution 3D space results in high computational expense. For instance, storing radiance information at 1-millimeter resolution for a 10-meter room requires a massive amount of data given that there are 10 billion cubic millimeters in a 10-meter room. Additionally, and as noted above, NeRF systems must use a volume renderer to generate views, which involves tracing rays through the cubes for each pixel. Again, considering the example of the 10-meter room, this requires approximately 82 billion calls to the neural net to achieve 4 k image resolution.

In view of the substantial computational and memory resources required to implement NeRF, NeRF has not been used to reconstruct dynamic scenes. This is at least partly because the NeRF model needs to be trained on each frame representing the scene, which requires prodigious amounts of memory and computing resources even in the case of dynamic scenes of short duration. Consequently, NeRF and other novel view scene encoding algorithms have been limited to modeling static objects and environments.

Thus, techniques are required to address the shortcomings of the prior art.

### SUMMARY

Embodiments of the present disclosure include a computer implemented method which includes receiving one or more keyframe images of a scene captured at an initial time and one or more first images of the scene captured a first time following the initial time. Each of the one or more keyframe images are associated with a corresponding three-dimensional (3D) camera location and camera direction included within a set of keyframe camera extrinsics. Each of the one or more first frame images is associated with a corresponding 3D camera location and camera direction included within a set of first frame camera extrinsics.

The method also includes training a keyframe neural network using the one or more keyframe images and the keyframe camera extrinsics. In some embodiments, the keyframe neural network includes a plurality of common layers and an initial plurality of adaptive layers. The method also includes training a first frame neural network using the one or more first frame images and the first frame camera extrinsics, the first frame neural network including a first plurality of adaptive layers and the plurality of common layers learned during training of the keyframe neural network. The method further includes transmitting the keyframe neural network and the first frame network to a receiving device configured to be queried to produce a first novel view of an appearance of the scene at the first time.

In some embodiments, the computer-implemented method includes receiving the one or more second images of the scene captured a second time following the first time where each of the one or more second frame images is associated with a corresponding 3D camera location and camera direction included within a set of second frame camera extrinsics.

Embodiments also include training a second frame neural network using the one or more second frame images and the second frame camera extrinsics, the second frame neural network including a second plurality of adaptive layers and the plurality of common layers learned during training of the keyframe neural network. Embodiments also include transmitting the second frame network to the receiving device where the receiving device is configured to be queried to produce a second novel view of an appearance of the scene at the second time.

In some embodiments, the computer-implemented method includes initializing the first plurality of adaptive layers using information included in the initial plurality of adaptive layers. In some embodiments, the computer-implemented method includes initializing the second plurality of adaptive layers using information included in the first plurality of adaptive layers.

In some embodiments, training the keyframe neural network includes training a keyframe encoder element included among the initial plurality of adaptive layers. In some embodiments, training the first frame neural network includes training a first encoder element included among the first plurality of adaptive layers. In some embodiments, training the second frame neural network includes training a second encoder element included among the first plurality of adaptive layers.

In some embodiments, the computer-implemented method includes transferring encoding information learned during of the keyframe encoder element to a first encoder element included among the first plurality of adaptive layers. In some embodiments, the computer-implemented method includes transferring the encoding information learned by the keyframe encoder element to a second encoder element included among the second plurality of adaptive layers.

In some embodiments, training the keyframe neural network includes passing the keyframe camera extrinsics through a predetermined function and providing an output of the predetermined function to an input of the plurality of common layers. Embodiments also include passing the keyframe camera extrinsics into the initial plurality of adaptive layers.

In some embodiments, training the first frame neural network includes passing the first frame camera extrinsics through the predetermined function and providing a resulting output to an input of the plurality of common layers within the first frame neural network. Embodiments may also include passing the first frame camera extrinsics into the first plurality of adaptive layers.

Embodiments of the present disclosure may also include a computer implemented method including receiving one or more keyframe images of a scene captured at an initial time, one or more first images of the scene captured a first time following the initial time, and one or more second images of the scene captured at a second time following the first time Each of the one or more keyframe images may be associated with a corresponding three-dimensional (3D) camera location and camera direction included within a set of keyframe camera extrinsics. Each of the one or more first frame images is associated with a corresponding 3D camera location and camera direction included within a set of first frame camera extrinsics. Each of the one or more second frame images is associated with a corresponding 3D camera location and camera direction included within a set of second frame camera extrinsics.

Embodiments also include training a keyframe neural network using the one or more keyframe images and the keyframe camera extrinsics, the one or more first frame images and first frame camera extrinsics and the one or more second frame images and second frame camera extrinsics. In some embodiments, the keyframe neural network includes a plurality of common layers and an initial plurality of adaptive layers.

Embodiments also include training a first frame neural network using the one or more first frame images and the first frame camera extrinsics, the first frame neural network including a first plurality of adaptive layers and the plurality of common layers learned during training of the keyframe neural network. Embodiments also include transmitting the keyframe neural network and the first frame network to a receiving device configured to be queried to produce a first novel view of an appearance of the scene at the first time.

In some embodiments, the computer-implemented method includes training a second frame neural network using the one or more second frame images and the second frame camera extrinsics, the second frame neural network including a second plurality of adaptive layers and the plurality of common layers learned during training of the keyframe neural network. Embodiments also include transmitting the second frame network to the receiving device where the receiving device is configured to be queried to produce a second novel view of an appearance of the scene at the second time.

In some embodiments, the computer-implemented method includes initializing the first plurality of adaptive layers using information included in the initial plurality of adaptive layers. In some embodiments, the computer-implemented method includes initializing the second plurality of adaptive layers using information included in the first plurality of adaptive layers.

Embodiments of the present disclosure also include a multi-network coder apparatus employing transfer learning, the coder apparatus including an input interface for receiving one or more keyframe images of a scene captured at an initial time, one or more first images of the scene capture a first time following the initial time, and one or more second images of the scene captured at a second time following the first time. Each of the one or more keyframe images may be associated with a corresponding three-dimensional (3D) camera location and camera direction included within a set of keyframe camera extrinsics. Each of the one or more first frame images may be associated with a corresponding 3D camera location and camera direction included within a set of first frame camera extrinsics. Each of the one or more second frame images may be associated with a corresponding 3D camera location and camera direction included within a set of second frame camera extrinsics.

Embodiments may also include a keyframe neural network in communication with the input interface, the keyframe neural network being trained using the one or more keyframe images and the keyframe camera extrinsics, the one or more first frame images and first frame camera extrinsics and the one or more second frame images and second frame camera extrinsics. In some embodiments, the keyframe neural network includes a plurality of common layers and an initial plurality of adaptive layers.

Embodiments may also include a first frame neural network configured to be trained using the one or more first frame images and the first frame camera extrinsics, the first frame neural network including a first plurality of adaptive layers and the plurality of common layers learned during training of the keyframe neural network. Embodiments also include a transmitter for transmitting the keyframe neural network and the first frame network to a receiving device configured to be queried to produce a first novel view of an appearance of the scene at the first time.

### BRIEF DESCRIPTION OF THE FIGURES

The invention is more fully appreciated in connection with the following detailed description taken in conjunction with the accompanying drawings, in which:

FIG. 1A illustrates a conventional process 10 for training a NeRF-based system to generate reconstructed views of a scene using captured images of the scene.

FIG. 1B shows neural network 20 queried using novel camera view(s) 19 specifying one or more viewing positions and directions corresponding to one or more virtual cameras.

FIG. 2 illustrates a high-level neural architecture of a neural network implementing a conventional NeRF.

FIG. 3 provides a more detailed view of an exemplary neural network implementing a conventional NeRF.

FIG. 4 illustrates a process 400 for training an exemplary multi-network encoder 410 to generate novel views of a dynamic scene.

FIG. 5 illustrates an exemplary implementation of the keyframe Artificial Neural Network (ANN) 430.

FIG. 6 depicts an ANN 600 having a common network 610 and an adaptive network 620 which has been configured to optimize the transfer learning formulation.

FIG. 7 illustrates a process 700 by which a trained multi-network encoder is queried to reconstruct a sequence of views of a dynamic scene spanning multiple frame times.

FIG. 8 illustrates a dynamic scene novel view synthesis (DSNVS) communication system 800 in accordance with an embodiment.

FIG. 9 illustrates another DSNVS communication system 900 in accordance with an embodiment.

FIG. 10 is a block diagram representation of an electronic device 1000 configured for operation as a DSNVS sending and/or DSNVS receiving device in accordance with an embodiment.

FIG. 11 is a flowchart characterizing a method used in accordance with an embodiment.

FIG. 12 is a flowchart that further characterizes the method of FIG. 11.

FIG. 13 is a flowchart that further characterizes the method from FIG. 11.

FIG. 14 is a flowchart that further characterizes the method from FIG. 11.

FIG. 15 is a flowchart that further characterizes the method from FIG. 11.

FIG. 16 is a flowchart that further characterizes the method from FIG. 11.

FIG. 17 is a flowchart that characterizes a method utilized in accordance with an embodiment of the invention.

FIG. 18 is a flowchart that further characterizes the method of FIG. 17.

FIG. 19 is a flowchart that further characterizes the method of FIG. 17.

FIG. 20 is a flowchart that further characterizes the method of FIG. 17.

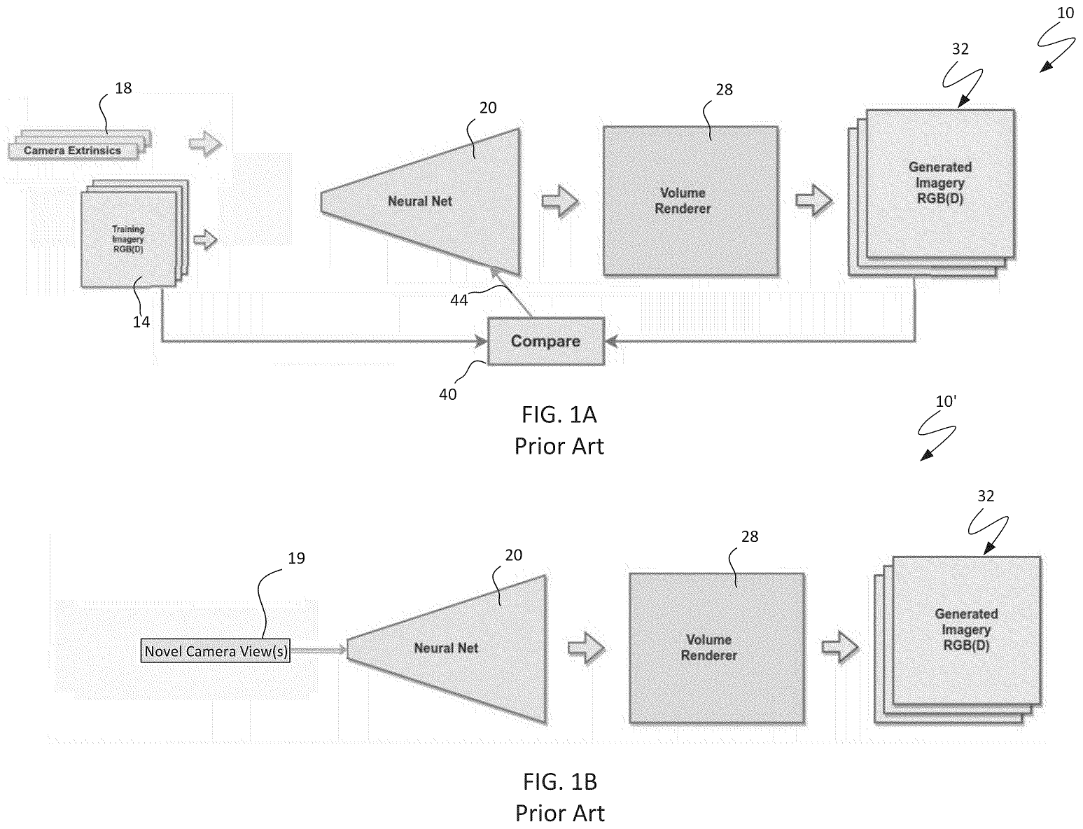

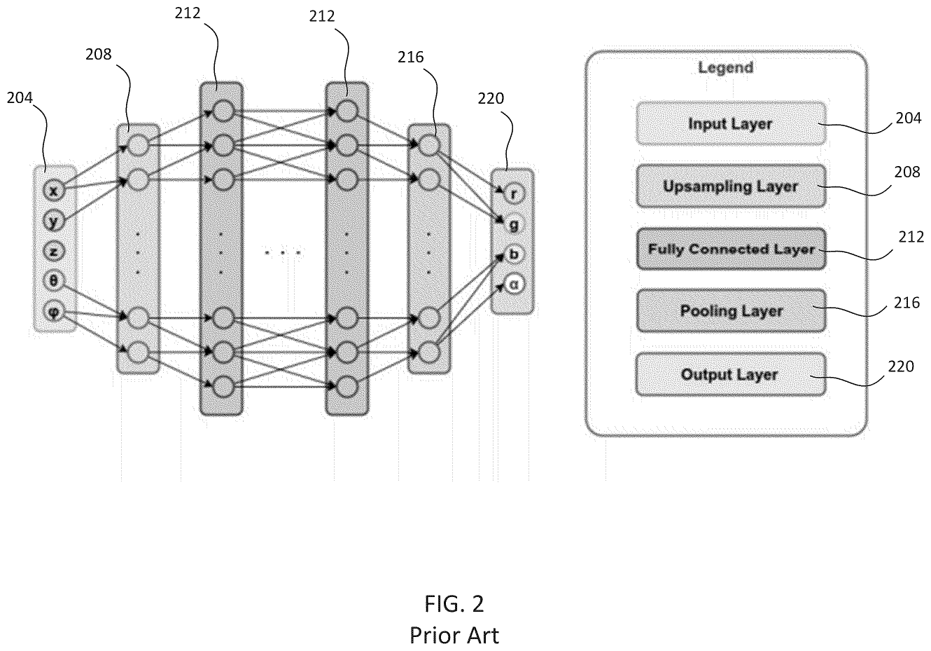

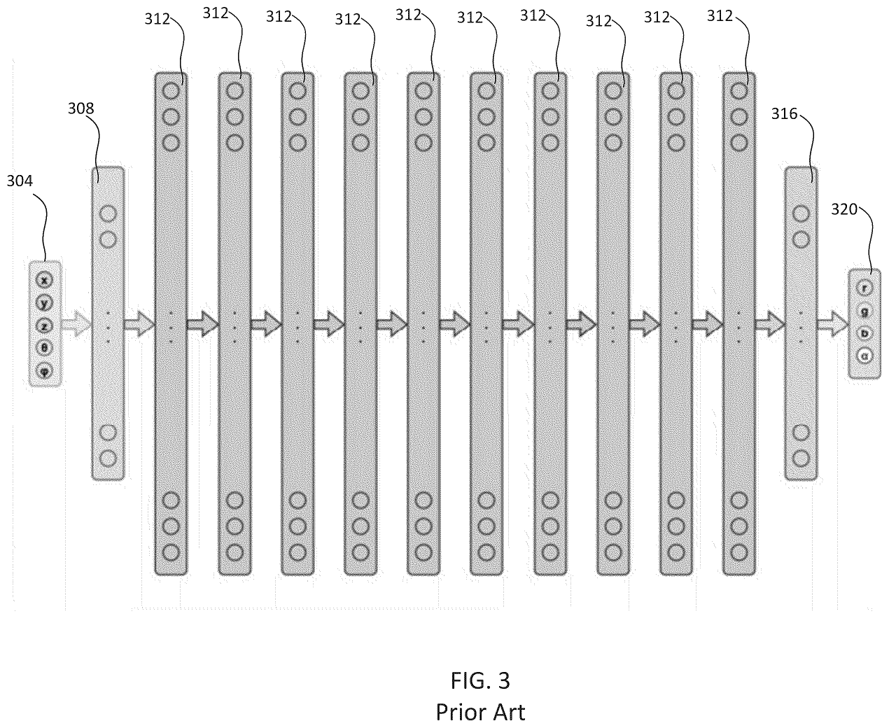

Like reference numerals refer to corresponding parts throughout the several views of the drawings.

### DETAILED DESCRIPTION

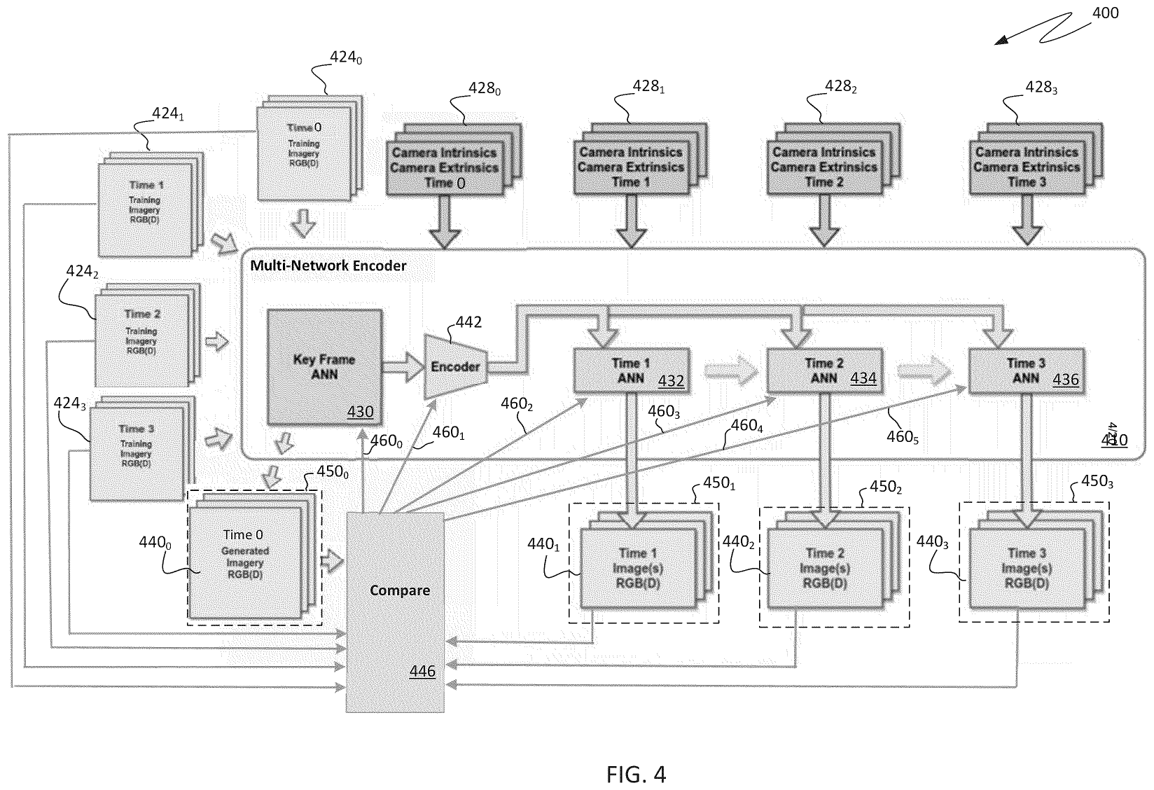

Attention is now directed to FIG. 4, which illustrates a process 400 for training an exemplary multi-network encoder 410 to generate novel views of a dynamic scene. As shown, the multi-network encoder 410 includes a plurality of artificial neural network (ANNs) including a keyframe ANN 430 corresponding to a keyframe. The encoder 410 also includes a plurality of ANNs dependent upon the keyframe ANN 430. These dependent ANNs include a first frame ANN 432 corresponding to a first frame following the keyframe, a second frame ANN 434 corresponding to a second frame following the keyframe and a third frame ANN 436 corresponding to a third frame following the keyframe. As is discussed below, the ANNs 430, 432, 434, 436 are trained by snapshots of the dynamic scene taken from varying perspectives at nearby timestamps to produce novel views of the dynamic scene at such timestamps. Specifically, training images 424 (e.g., video frames) of a scene are provided to the multi-network encoder 410 along with associated camera extrinsics 428 (e.g., a camera location in the form of voxel coordinates (x,y,z) and a camera pose in the form of an azimuth and elevation), as well as optional camera intrinsics. This training information is used by the multi-encoder network 410 in training of the keyframe ANN 430, the first frame ANN 432, the second frame ANN 434 and the third frame ANN 434. In general, the training images captured at a particular time will be captured by different physical cameras at different locations/orientations relative to the dynamic scene. For example, a set of physical cameras may be used to capture an initial set of training images 424₀ of a scene at an initial time (Time 0), a first set of training images 424₁ of the scene at a first time (Time 1), a second set of training images 424₂ of the scene at a second time (Time 2), and a third set of training images 424₃ of a the scene at a third time (Time 3).

The camera extrinsics 4280 associated with the training images 424₀ captured at the initial time (Time 0) may be provided to the multi-network encoder 410 to first train the keyframe ANN 430. Specifically, the camera extrinsics 4280 for each training image 424₀ are provided to an input of the keyframe ANN 430 and in response the keyframe ANN 430 generates an output. This output is provided to a rendering element 450₀, e.g., a volume renderer, which generates RGB (D) imagery 4400. This generated RGB (D) imagery 4400 is compared 446 with the training image 424₀ associated with the particular camera extrinsics 4280 input to the keyframe ANN 430. Based upon this comparison the parameters of the keyframe ANN 430 are adjusted 460 such that differences between the generated imagery 4400 and the training images 424₁ are minimized. As is discussed in further detail below, embodiments of the disclosure contemplate a transfer learning process pursuant to which certain information learned during training of the keyframe ANN 430 is used in training the first frame ANN 432, the second frame ANN 434 and the third frame ANN 436 in order to expedite and facilitate their training.

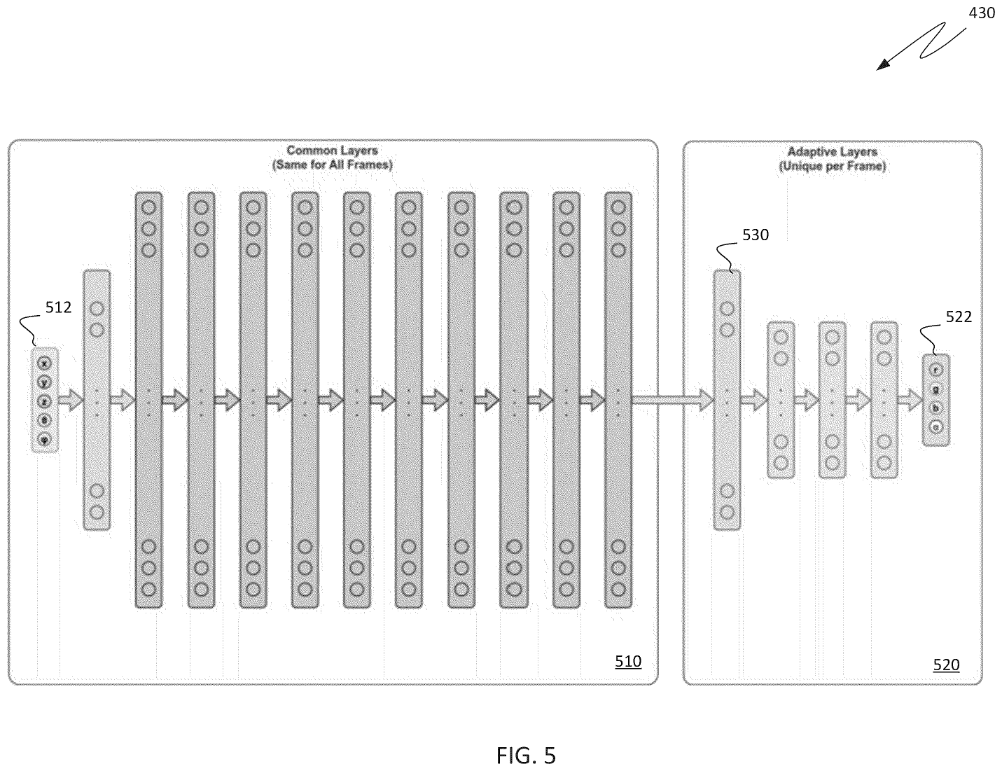

FIG. 5 illustrates an exemplary implementation of the keyframe ANN 430. As shown, the keyframe ANN 430 includes a common network 510 and an adaptive network 520. During training of the keyframe ANN 430 the camera extrinsics 4280 are applied to an input layer 512 of the common network 510 and the parameters of the common network 510 and the adaptive network 520 are adjusted such that the differences between the volume-rendered output of the keyframe ANN 430 and the training images 424₀ are minimized. In one embodiment the first frame ANN 432, the second frame ANN 434 and the third frame ANN 436 are dependent upon the keyframe ANN 430; that is, each of the first frame ANN 432, the second frame ANN 434 and the third frame ANN 436 reuses the common network 510 of the keyframe ANN 430 and includes an adaptive network unique to such frame. Once training of the keyframe ANN 430, the first frame ANN 432, the second frame ANN 434 and the third frame ANN 436 has been completed in the manner discussed below, the adaptive networks of each of these ANNs will hold unique neural space information.

Training of the first frame ANN 432, the second frame ANN 434 and the third frame ANN 436 may be affected in a similar manner as that described above with reference to the keyframe ANN 430. Once the common layers within the common network 510 of the have been learned, they may be reused in training of the first frame ANN 432. Specifically, in the case of the first frame ANN 432, the camera extrinsics 428₁ associated with training images 424₁ captured at the first time (Time 1) are provided to the input of the trained common network 510. In response, the trained common network 510 provides an output to the variable network of the first frame ANN 432, which in turn generates an output. The output from the variable network of the first frame ANN 432 is provided to a rendering element 450₁, e.g., a volume renderer, which generates RGB (D) imagery 440₁. This generated RGB (D) imagery 440₁ is compared 446 with the training image 424₁ associated with the particular camera extrinsics 428₁. Based upon this comparison the parameters of the adaptive layer structure of the first frame ANN 432 are adjusted 446 such that differences between the generated imagery 440₁ and the training images 424₁ are minimized. The second frame ANN 434 and the third frame ANN 436 may be similarly trained and are associated with rendering elements 450₂ and 450₃, where the rendering elements 450_{0,1,2,3} may be separate rendering element instances or a single rendering element re-used by the ANNs 430, 432, 434, 436. It may be appreciated that the adaptive networks of the first frame ANN 432, the second frame ANN 434 and the third frame ANN 436 manifest a form of transfer learning and effect the minor “temporal corrections” needed to accurately produce frames subsequent to the keyframe.

In one embodiment the multi-network encoder 410 further includes an encoder 442 comprised of an encoder layer 530 (FIG. 5) within the adaptive network of each of the ANNs 430, 432, 434, 436. The encoder layers 530 of the encoder 410 may be jointly trained with the common network 510 of the keyframe ANN 430, although this is not a requirement. When trained with the common network 510 of the keyframe ANN 430 the encoder layer 530 may be viewed as optional variation on the keyframe architecture. In other embodiments the encoder layer 530 could be specialized for each adaptive network.

In low-latency applications the layers of the common network 510 may be learned based upon training using only the keyframe training imagery 424₀; that is, the layers of the common network 510 are frozen for subsequent frames. In more latency-tolerant applications, the common network 510 may be trained using the keyframe training imagery 424₀ together with the training imagery 424₁, 424₂, 424₃, for all subsequent frames. In this structure less information is transmitted, especially considering that a fully connected layer has connections that grow with the square of the number of channels, thus making the multi-network encoder 410 more suitable for use as a video/streaming holographic codec.

It may be appreciated that one objective of the architecture of FIGS. 4 and 5 is to reduce the dimensionality of the keyframe ANN output layer; that is, reduce the number of ANN channels. The motivation for this is that (1) it may produce a more generalizable output that would be useful to subsequent frames' adaptive networks, and (2) it reduces the input size to each of those adaptive layers once, so that that structure doesn't have to be repeated in each of the adaptive layers, which reduces computation and the storage/transmission bandwidth for those adaptive layers.

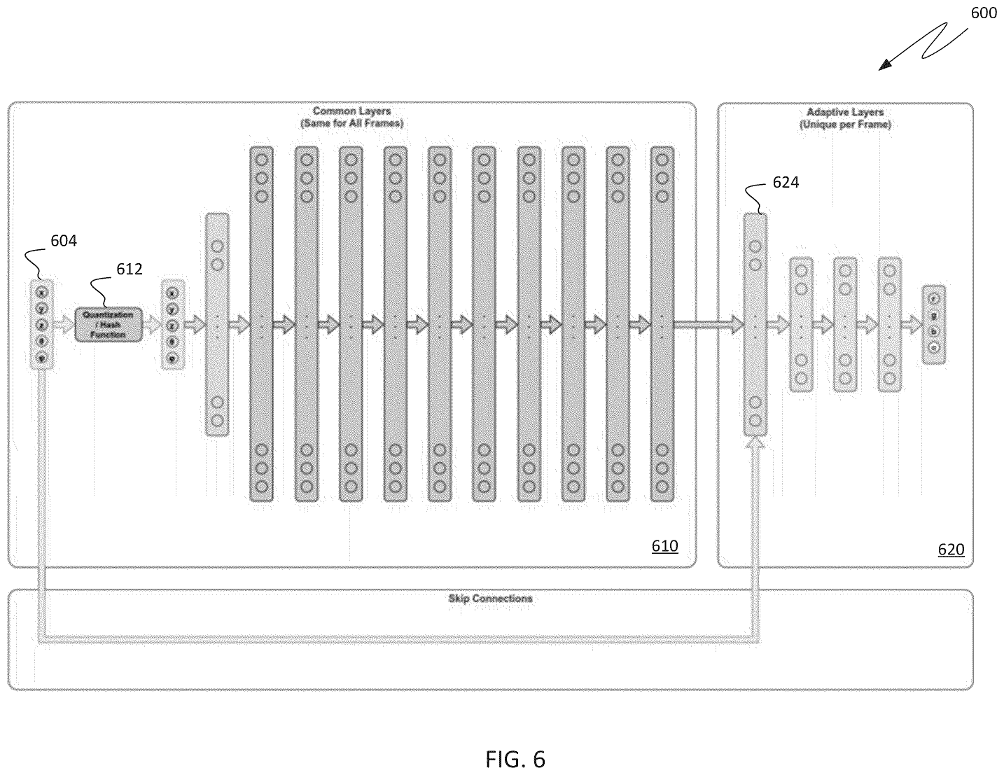

FIG. 6 depicts an ANN 600 having a common network 610 and an adaptive network 620 which has been configured to optimize the transfer learning formulation discussed above with reference to FIG. 5 without loss of resolution. As shown in FIG. 6, input coordinates 604 are passed to layers of the common network 610 through an input function 612, such as a quantization or a multi-level hash, which allows for a smaller common network 610 to be utilized. See “Instant neural graphics primitives with a multiresolution hash encoding”, Müller et al., ACM Trans. Graph., vol. 41, no. 4, pp. 102:1-102:15, July 2022 (https://doi.org/10.1145/3528223.3530127). This results in savings of compute time and in transmission bandwidth during training, transmission and querying of the ANNs 430, 432, 434, 436. Although use of the input function 612 could potentially lower the resolution of the information provided by the common network 610, in accordance with the disclosure this is avoided and detail is preserved detail by passing the input coordinates into encoder layer 624 of the adaptive network 620. Thus, the adaptive layers of the adaptive network 620 can be seen as a spatio-temporal correction to the common layers of the common network. This optimization through use of input function 612 does not preclude use of other techniques to improve accuracy (e.g., spatial encoding). As was discussed with reference to FIGS. 4 and 5, once the common network 610 has been trained along with the adaptive network 620 of the keyframe it may be re-used in training of the adaptive networks of subsequent frames following the keyframe.

In other embodiments the adaptive network of the ANN associated with a given frame could be initialized with the training results from the previous frame. For example, once the adaptive network of the first frame ANN 432 has been trained using the training imagery 424₁ and the camera extrinsics 428₁, the learned information stored by the adaptive network of the first frame ANN 432 can be transferred to the adaptive network of the second frame ANN 434. In many embodiments without excessive scene motion this type of an initialization process should be feasible in view of the relatively small changes occurring between frames.

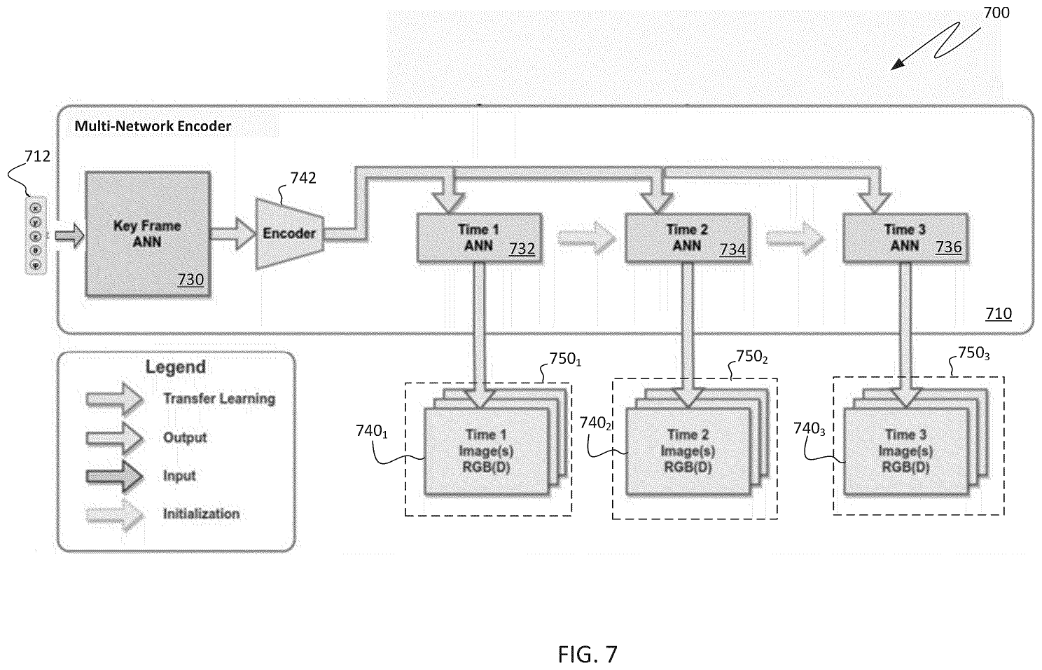

FIG. 7 illustrates a process 700 by which a multi-network encoder 710 trained as described with reference to FIGS. 4-6 may be queried to reconstruct a sequence of views of a dynamic scene spanning multiple frame times. The multi-network encoder 710 may be utilized as part of a codec to, for example, facilitate 3D aware video communication. As is discussed below, the results from querying a previous frame ANN 730 (e.g., a keyframe) using coordinates 712 corresponding to a desired novel view of the dynamic scene may be reused in the inference of smaller dependent ANNs 732, 734, 736 for subsequent frames. Specifically, the keyframe ANN 730 generates an output based upon the query coordinates 712 and this output from the keyframe ANN 730 is provided as an input to the adaptive networks of the ANNs 732, 734, 736. Outputs provided by the adaptive networks of the ANNs 732, 734, 736 are then provided to rendering elements 750₁, 750₂, 750₃ (which may be implemented as separate instances or as a single rendering element which is re-used by the ANNs 732, 734, 736) disposed to generate RGB (D) imagery 740₁, 740₂, 740₃. The imagery 740₁, 740₂, 740₃ provides novel reconstructed views of the dynamic scene at adjacent points in time.

As shown, in one embodiment the multi-network encoder 710 further includes an encoder 742 comprised of encoder layers 530 within the adaptive networks of the ANNs 730, 732, 734, 736. In addition, although the smaller ANNs 732, 734, 736 for subsequent adjacent frames will be different due to any motion, in one embodiment a preceding ANN (e.g., ANN 732) may be used to initialize inference in an immediately following ANN (e.g., ANN 734).

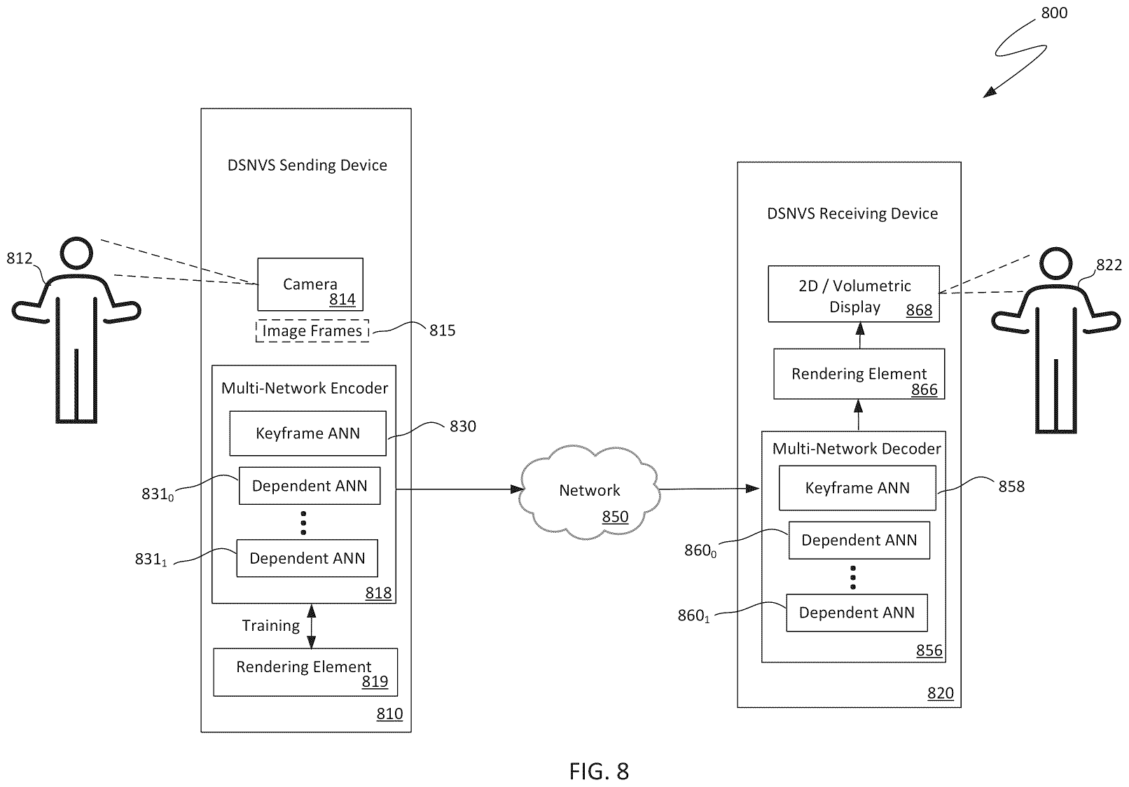

Attention is now directed to FIG. 8, which illustrates dynamic scene novel view synthesis (DSNVS) communication system 800 in accordance with an embodiment. The system 800 includes a DSNVS sending device 810 associated with a first user 812 and a DSNVS receiving device 820 associated with a second user 822. During operation of the system 800 a camera 814 within the DSNVS sending device 810 captures images 815 of an object or a static or dynamic scene. For example, the camera 814 may record a video including a sequence of image frames 815 of the object or scene. The first user 812 may or may not be appear within the image frames 815. The DSNVS sending device 810 may be configured to train a multi-network encoder 818 to model the object or static/dynamic scene at multiple points in time using the image frames 815. In one embodiment the multi-network encoder 818 may include a keyframe ANN 830 and multiple dependent frame ANNs 831. As was discussed above, the encoder 818 performs a training operation in conjunction with a rendering element 819 to train the ANNs 830, 831 using the image frames 815. The training operation may include, for example, providing the image frames 815 to the encoder 818 for use in reconstructing views of the scene using the rendering element 819. In an initial training phase the parameters of the keyframe ANN 830 are adjusted based upon a comparison between the reconstructed scene views output by the rendering element 810 and the image frames 815. As was discussed above, following this initial training phase a common network of the keyframe ANN 830 is re-used in training of the dependent ANNs 831.

Once training of the multi-network encoder 818 based upon the image frames 815 has been completed, the ANNs 830, 831 of the multi-network encoder 818 are sent by the DSNVS sending device 810 over a network 850 to the DSNVS receiving device 820. Once received in the DSNVS receiving device 820, the ANNs 830, 831 are instantiated as a multi-network decoder 856 configured to replicate the multi-network encoder 818. As shown, the multi-network decoder 856 includes a keyframe ANN 858 substantially identical to the keyframe ANN 830 and dependent frame ANNs 860 substantially identical to the dependent frame ANNs 831. The multi-network decoder 856 operates, in conjunction with a rendering element 866, to reconstruct a sequence of views of the object or scene captured by the image frames 815. In accordance with the disclosure, this reconstructed sequence of views of the object or scene is “3D aware” in that the user of the device 820 may specify a virtual camera location and orientation with respect to which to novel views of the dynamic scene may be rendered at adjacent points in time, e.g., over a sequence of frame times. A user of the device 820 may view this sequential reconstruction of frames of the dynamic scene provided by the rendering element 866 using a two-dimensional or volumetric display 868.

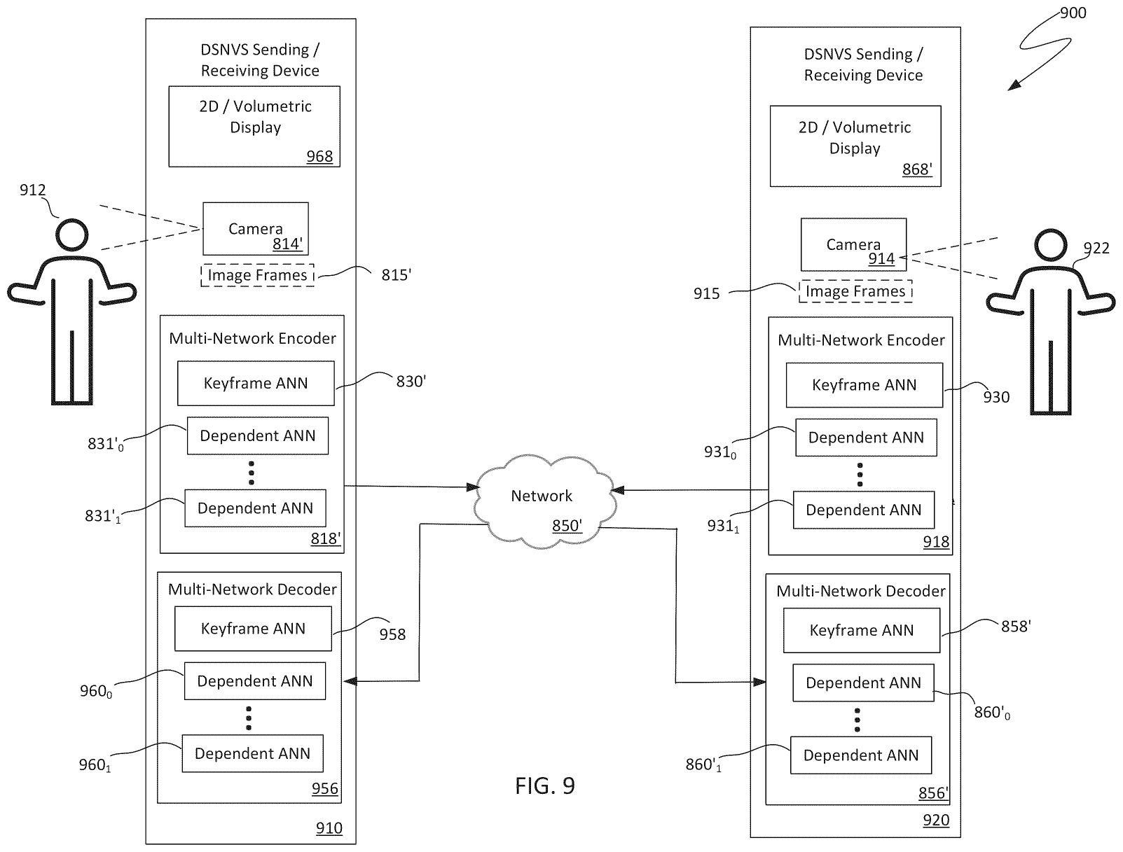

FIG. 9 illustrates another DSNVS communication system 900 in accordance with an embodiment. As may be appreciated by comparing FIGS. 8 and 9, the DSNVS communication systems share certain similarities. In view of these similarities certain system elements in FIG. 9 are identified using primed reference numerals to highlight their similarity to corresponding elements in FIG. 8. As shown, the communication system 900 includes a first DSNVS sending/receiving device 910 utilized by a first user 912 and a second DSNVS sending/receiving device 920 utilized by a second user 922. The first DSNVS sending/receiving device 910 includes a camera 814′ configured to captures images 815′ of a scene, e.g., a dynamic scene including motion. The first DSNVS sending/receiving device 910 may be configured to train a multi-network encoder 818′ to model the scene at multiple points in time using the image frames 815′. The multi-network encoder 818′ may include a keyframe ANN 830′ and multiple dependent frame ANNs 831′. Once training of the multi-network encoder 818′ based upon the image frames 815′ has been completed, the ANNs 830′, 831′ of the multi-network encoder 818′ are sent by the DSNVS device 910 over a network 850′ to the DSNVS device 920. Once received in the DSNVS device 920, the ANNs 830′, 831′ are instantiated as a multi-network decoder 856′ configured to replicate the multi-network encoder 818′. As shown, the multi-network decoder 856′ includes a keyframe ANN 858′ substantially identical to the keyframe ANN 830′ and dependent frame ANNs 860′ substantially identical to the dependent frame ANNs 831′.

The second DSNVS sending/receiving device 920 may be configured to train a multi-network encoder 918 to model the scene at multiple points in time using image frames 915 captured by a camera 914. The multi-network encoder 918 may include a keyframe ANN 930 and multiple dependent frame ANNs 931. Once training of the multi-network encoder 918 based upon the image frames 915 has been completed, the ANNs 930, 931 of the multi-network encoder 918 are sent by the DSNVS device 920 over the network 850′ to the DSNVS device 910. Once received in the DSNVS device 910, the ANNs 930, 931 are instantiated as a multi-network decoder 956 configured to replicate the multi-network encoder 918. As shown, the multi-network decoder 956 includes a keyframe ANN 958 substantially identical to the keyframe ANN 930 and dependent frame ANNs 960 substantially identical to the dependent frame ANNs 931.

In the embodiment of FIG. 9 both the first DSNVS sending/receiving device 910 and the second DSNVS/sending receiving device 920 can generate multi-network models of a dynamic scene over adjacent timestamps, sending such models to one or more other devices, and reconstructing novel sequences of views of other dynamic scenes using multi-network models received from such other devices. For example, the first user 912 and the second user 922 could use their respective DSNVS sending/receiving devices 910, 920 to engage in a communication session during which each user 912, 922 could, preferably in real time, view and communicate with the other user 912, 922 in a 3D aware manner. That is, each user 912, 922 could view frame sequences of a dynamic scene captured the device 910, 920 of the other user from a novel virtual camera location and orientation, preferably in real time. In embodiments in which the displays 968, 868′ of the devices 910, 920 are implemented as volumetric displays configured to volumetrically display the captured frame sequences of the objects or scene, such 3D aware communication effectively becomes a form of real-time or near real-time holographic communication.

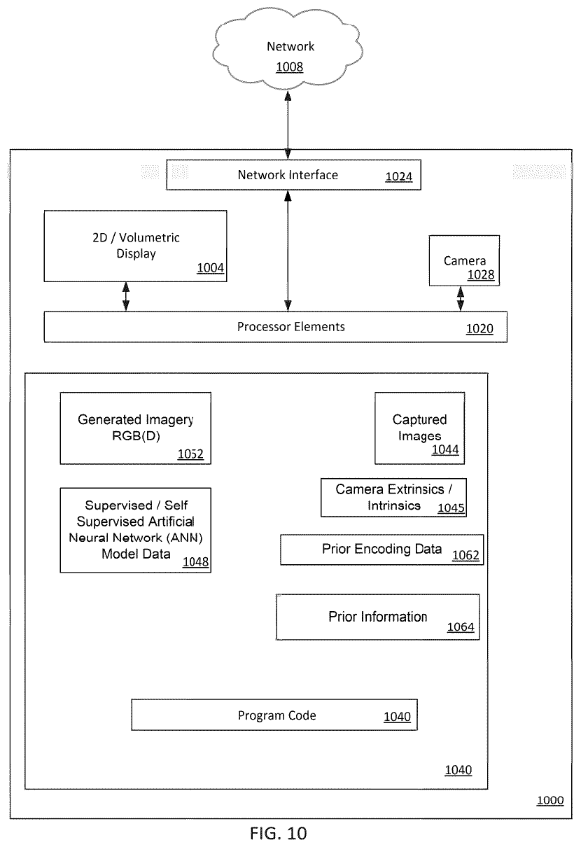

Attention is now directed to FIG. 10, which includes a block diagram representation of an electronic device 1000 configured to operation as a DSNVS sending and/or DSNVS receiving device in accordance with the disclosure. It will be apparent that certain details and features of the device 1000 have been omitted for clarity, however, in various implementations, various additional features of an electronic tablet as are known will be included. The device 1000 may be in communication with another DSNVS sending and receiving device (not shown) via a communications link which may include, for example, the Internet, the wireless network 1008 and/or other wired or wireless networks. The device 1000 includes one or more processor elements 1020 which may include, for example, one or more central processing units (CPUs), graphics processing units (GPUs), neural processing units (NPUs), neural network accelerators (NNAs), application specific integrated circuits (ASICs), and/or digital signal processors (DSPs). As shown, the processor elements 1020 are operatively coupled to a touch-sensitive 2D/volumetric display 1004 configured to present a user interface. The touch-sensitive display 1004 may comprise a conventional two-dimensional (2D) touch-sensitive electronic display (e.g., a touch-sensitive LCD display). Alternatively, the touch-sensitive display 1004 may be implemented using a touch-sensitive volumetric display configured to render information holographically. See, e.g., U.S. Patent Pub. No. 20220404536 and U.S. Patent Pub. No. 20220078271. The device 1000 may also include a network interface 1024, one or more cameras 1028, and a memory 1040 comprised of one or more of, for example, random access memory (RAM), read-only memory (ROM), flash memory and/or any other media enabling the processor elements 1020 to store and retrieve data. The memory 1040 stores program code 1040 and/or instructions executable by the processor elements 1020 for implementing the computer-implemented methods described herein.

The memory 1040 is also configured to store captured images 1044 of a scene which may comprise, for example, video data or a sequence of image frames captured by the one or more cameras 1028. Camera extrinsics/intrinsics 1045 associated with the location and pose and other details of the camera 1028 used to acquire each image within the captured images 1044 is also stored. The memory 1040 may also contain neural network information 1048 defining one or more neural network models, including but not limited to one or more encoder-decoder networks for implementing the methods described herein. The neural network information 1048 will generally include neural network model data sufficient to train and utilize the neural network models incorporated within the DSNVS encoders and decoders described herein. The memory 1040 may also store generated imagery 1052 created during operation of the device as a DSNVS receiving device. As shown, the memory 1040 may also store prior frame encoding data 1062 (e.g., data defining a prior frame, initialization frame or keyframe) and other prior information 1064.

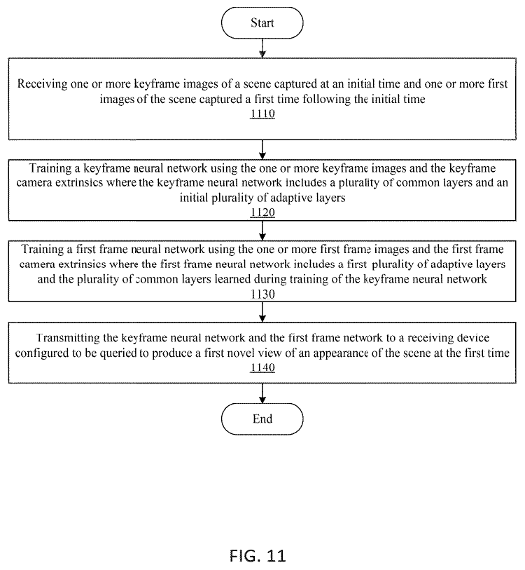

FIG. 11 is a flowchart that describes method, according to some embodiments of the present disclosure. In some embodiments, at 1110, the method may include receiving one or more keyframe images of a scene captured at an initial time and one or more first images of the scene captured a first time following the initial time where each of the one or more keyframe images may be associated with a corresponding three-dimensional (3D) camera location and camera direction included within a set of keyframe camera extrinsics and each of the one or more first frame images may be associated with a corresponding 3D camera location and camera direction included within a set of first frame camera extrinsics.

In some embodiments, at 1120, the method may include training a keyframe neural network using the one or more keyframe images and the keyframe camera extrinsics. The keyframe neural network may include a plurality of common layers and an initial plurality of adaptive layers. At 1130, the method may include training a first frame neural network using the one or more first frame images and the first frame camera extrinsics, the first frame neural network including a first plurality of adaptive layers and the plurality of common layers learned during training of the keyframe neural network. At 1140, the method may include transmitting the keyframe neural network and the first frame network to a receiving device configured to be queried to produce a first novel view of an appearance of the scene at the first time.

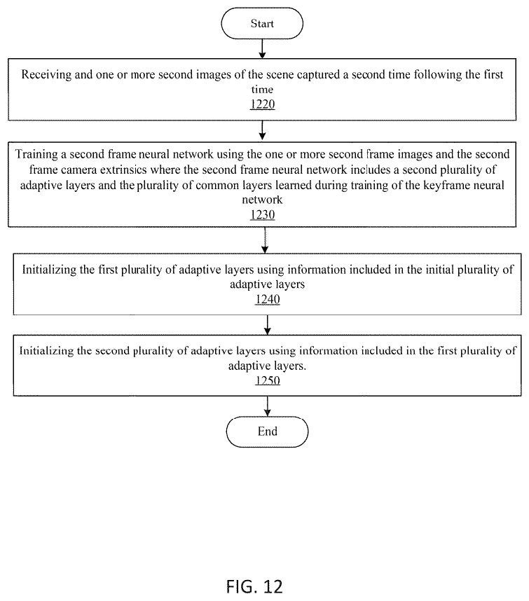

FIG. 12 is a flowchart that further describes the method from FIG. 11, according to some embodiments of the present disclosure. In some embodiments, at 1220, the computer-implemented method may include receiving and one or more second images of the scene captured a second time following the first time where each of the one or more second frame images may be associated with a corresponding 3D camera location and camera direction included within a set of second frame camera extrinsics. At 1230, the computer-implemented method may include training a second frame neural network using the one or more second frame images and the second frame camera extrinsics, the second frame neural network including a second plurality of adaptive layers and the plurality of common layers learned during training of the keyframe neural network. In some embodiments, at 1240, the computer-implemented method may include initializing the first plurality of adaptive layers using information included in the initial plurality of adaptive layers. In some embodiments, at 1250, the computer-implemented method may include initializing the second plurality of adaptive layers using information included in the first plurality of adaptive layers.

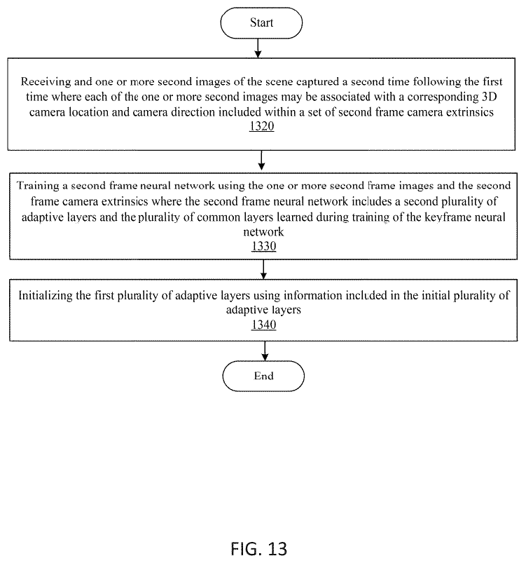

FIG. 13 is a flowchart that further describes the method from FIG. 11, according to some embodiments of the present disclosure. In some embodiments, at 1320, the computer-implemented method may include receiving and one or more second images of the scene captured a second time following the first time where each of the one or more second frame images may be associated with a corresponding 3D camera location and camera direction included within a set of second frame camera extrinsics. At 1330, the computer-implemented method may include training a second frame neural network using the one or more second frame images and the second frame camera extrinsics, the second frame neural network including a second plurality of adaptive layers and the plurality of common layers learned during training of the keyframe neural network.

In some embodiments, at 1340, the computer-implemented method may include initializing the first plurality of adaptive layers using information included in the initial plurality of adaptive layers. In some embodiments, the training the keyframe neural network may include training a keyframe encoder element included among the initial plurality of adaptive layers. In some embodiments, the training the first frame neural network may include training a first encoder element included among the first plurality of adaptive layers. In some embodiments, the training the second frame neural network may include training a second encoder element included among the first plurality of adaptive layers.

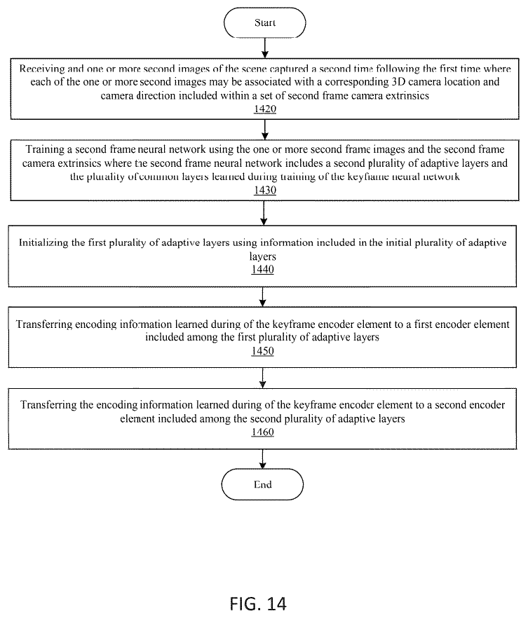

FIG. 14 is a flowchart that further describes the method from FIG. 11, according to some embodiments of the present disclosure. In some embodiments, at 1420, the computer-implemented method may include receiving and one or more second images of the scene captured a second time following the first time where each of the one or more second frame images may be associated with a corresponding 3D camera location and camera direction included within a set of second frame camera extrinsics. At 1430, the computer-implemented method may include training a second frame neural network using the one or more second frame images and the second frame camera extrinsics, the second frame neural network including a second plurality of adaptive layers and the plurality of common layers learned during training of the keyframe neural network.

In some embodiments, at 1440, the computer-implemented method may include initializing the first plurality of adaptive layers using information included in the initial plurality of adaptive layers. In some embodiments, the training the keyframe neural network may include training a keyframe encoder element included among the initial plurality of adaptive layers. In some embodiments, at 1450, the computer-implemented method may include transferring encoding information learned during of the keyframe encoder element to a first encoder element included among the first plurality of adaptive layers. In some embodiments, at 1460, the computer-implemented method may include transferring the encoding information learned during of the keyframe encoder element to a second encoder element included among the second plurality of adaptive layers.

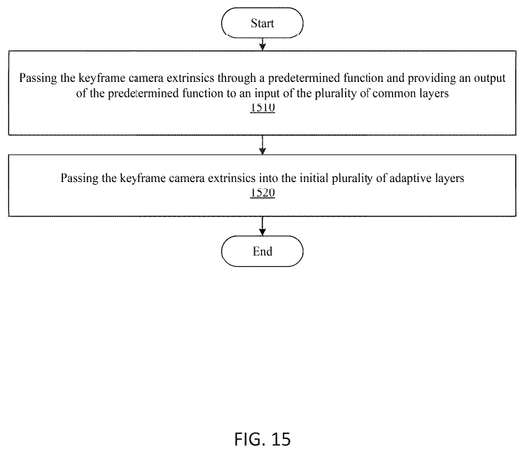

FIG. 15 is a flowchart that further describes the method from FIG. 11, according to some embodiments of the present disclosure. In 1510, the training the keyframe neural network may further include passing the keyframe camera extrinsics through a predetermined function and providing an output of the predetermined function to an input of the plurality of common layers. In 1520, the keyframe camera extrinsics are passed into the initial plurality of adaptive layers.

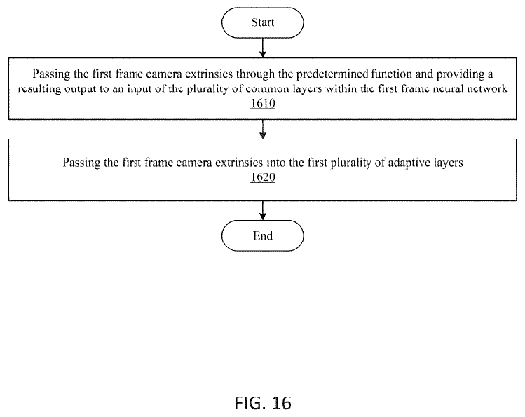

FIG. 16 is a flowchart that further describes the method from FIG. 11, according to some embodiments of the present disclosure. In some embodiments, the training the first frame neural network may include passing the first frame camera extrinsics through the predetermined function and providing a resulting output to an input of the plurality of common layers within the first frame neural network (stage 1610). In a stage 1620 the method of FIG. 11 may further include passing the first frame camera extrinsics into the first plurality of adaptive layers.

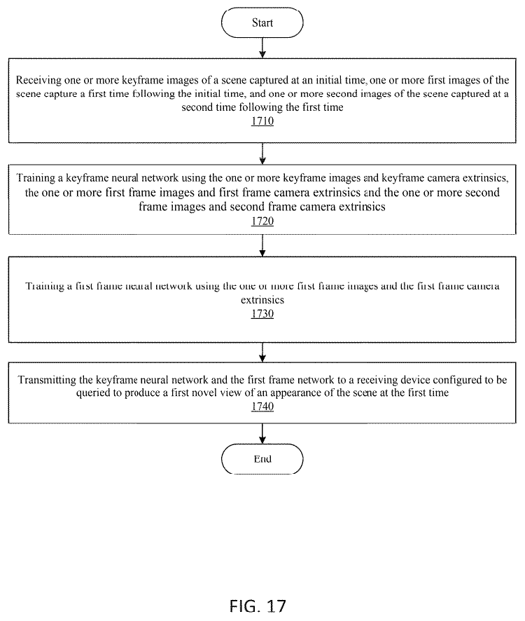

FIG. 17 is a flowchart that describes method, according to some embodiments of the present disclosure. In some embodiments, at 1710, the method may include receiving one or more keyframe images of a scene captured at an initial time, one or more first images of the scene capture a first time following the initial time, and one or more second images of the scene captured at a second time following the first time, where each of the one or more keyframe images may be associated with a corresponding three-dimensional (3D) camera location and camera direction included within a set of keyframe camera extrinsics, each of the one or more first frame images may be associated with a corresponding 3D camera location and camera direction included within a set of first frame camera extrinsics and each of the one or more second frame images may be associated with a corresponding 3D camera location and camera direction included within a set of second frame camera extrinsics.

In some embodiments, at 1720, the method may include training a keyframe neural network using the one or more keyframe images and the keyframe camera extrinsics, the one or more first frame images and first frame camera extrinsics and the one or more second frame images and second frame camera extrinsics. The keyframe neural network may include a plurality of common layers and an initial plurality of adaptive layers. At 1730, the method may include training a first frame neural network using the one or more first frame images and the first frame camera extrinsics, the first frame neural network including a first plurality of adaptive layers and the plurality of common layers learned during training of the keyframe neural network. At 1740, the method may include transmitting the keyframe neural network and the first frame network to a receiving device configured to be queried to produce a first novel view of an appearance of the scene at the first time.

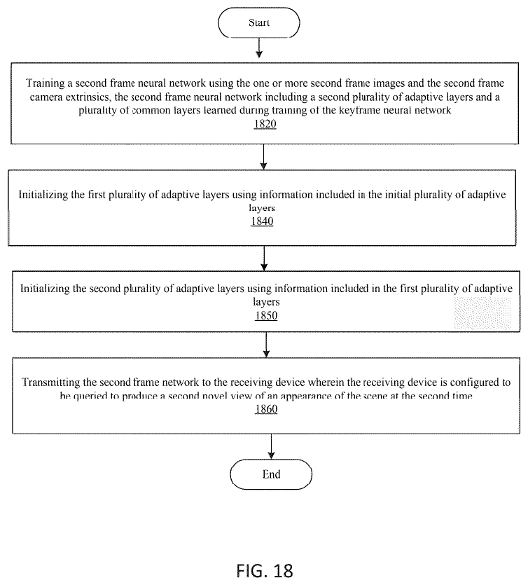

FIG. 18 is a flowchart that further describes the method from FIG. 17, according to some embodiments of the present disclosure. In some embodiments, at 1820, the computer-implemented method may include training a second frame neural network using the one or more second frame images and the second frame camera extrinsics, the second frame neural network including a second plurality of adaptive layers and the plurality of common layers learned during training of the keyframe neural network. In some embodiments, at 1840, the computer-implemented method may include initializing the first plurality of adaptive layers using information included in the initial plurality of adaptive layers. In some embodiments, at 1850, the computer-implemented method may include initializing the second plurality of adaptive layers using information included in the first plurality of adaptive layers. At 1860, the computer-implemented method may include transmitting the second frame network to the receiving device wherein the receiving device is configured to be queried to produce a second novel view of an appearance of the scene at the second time.

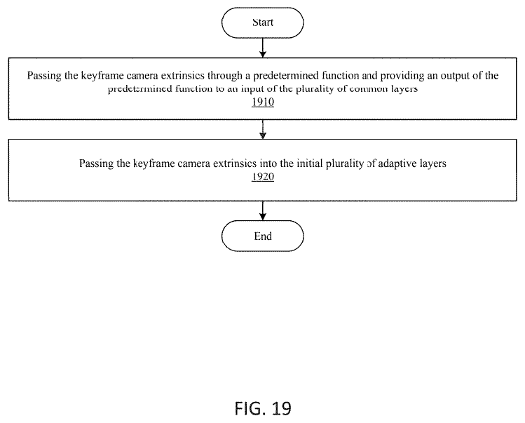

FIG. 19 is a flowchart that further describes the method from FIG. 17, according to some embodiments of the present disclosure. In some embodiments, the training the keyframe neural network may include, the method may include passing the keyframe camera extrinsics through a predetermined function and providing an output of the predetermined function to an input of the plurality of common layers. In 1920, the keyframe camera extrinsics are passed into the initial plurality of adaptive layers.

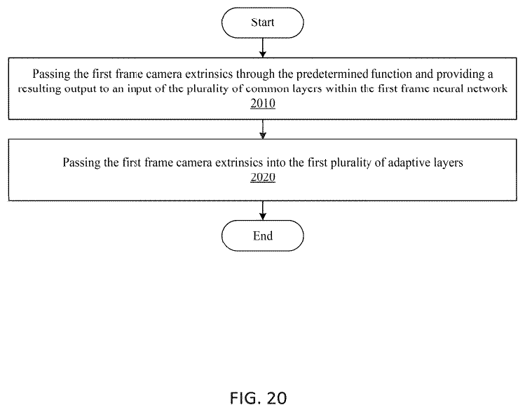

FIG. 20 is a flowchart that further describes the method from FIG. 17, according to some embodiments of the present disclosure. In some embodiments, the training the first frame neural network may include passing the first frame camera extrinsics through the predetermined function and providing a resulting output to an input of the plurality of common layers within the first frame neural network (stage 2010). In a stage 2020 the method of FIG. 17 may further include passing the first frame camera extrinsics into the first plurality of adaptive layers.

Where methods described above indicate certain events occurring in certain order, the ordering of certain events may be modified. Additionally, certain of the events may be performed concurrently in a parallel process when possible, as well as performed sequentially as described above. Accordingly, the specification is intended to embrace all such modifications and variations of the disclosed embodiments that fall within the spirit and scope of the appended claims.

The foregoing description, for purposes of explanation, used specific nomenclature to provide a thorough understanding of the claimed systems and methods. However, it will be apparent to one skilled in the art that specific details are not required to practice the systems and methods described herein. Thus, the foregoing descriptions of specific embodiments of the described systems and methods are presented for purposes of illustration and description. They are not intended to be exhaustive or to limit the claims to the precise forms disclosed; obviously, many modifications and variations are possible in view of the above teachings. The embodiments were chosen and described to best explain the principles of the described systems and methods and their practical applications, they thereby enable others skilled in the art to best utilize the described systems and methods and various embodiments with various modifications as are suited to the particular use contemplated. It is intended that the following claims and their equivalents define the scope of the systems and methods described herein.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer implemented method comprising:
receiving one or more keyframe images of a scene captured at an initial time and one or more first images of the scene captured a first time following the initial time where each of the one or more keyframe images is associated with a corresponding three-dimensional (3D) camera location and camera direction included within a set of keyframe camera extrinsics and each of the one or more first frame images is associated with a corresponding 3D camera location and camera direction included within a set of first frame camera extrinsics;
training a keyframe neural network using the one or more keyframe images and the keyframe camera extrinsics wherein the keyframe neural network includes a plurality of common layers and an initial plurality of adaptive layers;
training a first frame neural network using the one or more first frame images and the first frame camera extrinsics, the first frame neural network including a first plurality of adaptive layers and the plurality of common layers learned during training of the keyframe neural network; and
wherein the first frame neural network is configured to be queried to produce a first novel view of an appearance of the scene at the first time.

2. The computer-implemented method of claim 1 further including:
receiving and one or more second images of the scene captured a second time following the first time where each of the one or more second frame images is associated with a corresponding 3D camera location and camera direction included within a set of second frame camera extrinsics;
training a second frame neural network using the one or more second frame images and the second frame camera extrinsics, the second frame neural network including a second plurality of adaptive layers and the plurality of common layers learned during training of the keyframe neural network; and
wherein the second frame neural network is configured to be queried to produce a second novel view of an appearance of the scene at the second time.

3. The computer-implemented method of claim 1 wherein the training the keyframe neural network includes:
passing the keyframe camera extrinsics through a predetermined function and providing an output of the predetermined function to an input of the plurality of common layers;
passing the keyframe camera extrinsics into the initial plurality of adaptive layers.

4. The computer-implemented method of claim 1 wherein the training the first frame neural network includes:
passing the first frame camera extrinsics through the predetermined function and providing a resulting output to an input of the plurality of common layers within the first frame neural network;
passing the first frame camera extrinsics into the first plurality of adaptive layers.

5. The computer-implemented method of claim 2 further including initializing the first plurality of adaptive layers using information included in the initial plurality of adaptive layers.

6. The computer-implemented method of claim 5 further including initializing the second plurality of adaptive layers using information included in the first plurality of adaptive layers.

7. The computer-implemented method of claim 5 wherein the training the keyframe neural network includes training a keyframe encoder element included among the initial plurality of adaptive layers.

8. The computer-implemented method of claim 7 wherein the training the first frame neural network includes training a first encoder element included among the first plurality of adaptive layers.

9. The computer-implemented method of claim 8 wherein the training the second frame neural network includes training a second encoder element included among the first plurality of adaptive layers.

10. The computer-implemented method of claim 7 further including transferring encoding information learned during of the keyframe encoder element to a first encoder element included among the first plurality of adaptive layers.

11. The computer-implemented method of claim 10 further including transferring the encoding information learned during of the keyframe encoder element to a second encoder element included among the second plurality of adaptive layers.

12. The computer-implemented method of claim 1 further including:
transmitting at least the keyframe neural network and the first frame neural network to a viewing device including a volume rendering element and instantiating the keyframe neural network and the first frame neural network on the viewing device as a novel view synthesis (NVS) decoder;
wherein the NVS decoder is configured to be queried with coordinates corresponding to novel 3D views of the scene and to responsively generate output causing the volume rendering element to produce to imagery corresponding to the novel 3D views of the scene.
